(19) United States
(12) Patent Application Publication
(10) Pub. No.: US 2021/0383059 A1
(43) Pub. Date: Dec. 9, 2021

(54) Attribution Of Link Selection By A User

(71) Applicant: Awin Ltd., London (GB)

(72) Inventors: Fabian Schultz, lsernhagen (DE); Sebastian Jonas, Wennigsen (DE); Stephen Short, London (GB)

(73) Assignee: Awin Ltd., London (GB)

(21) Appl. No.: 17/086,035

(22) Filed: Oct. 30, 2020

Related U.S. Application Data
(60) Provisional application No. 63/033,834, filed on Jun. 3, 2020.

(51) Int. Cl. G06F 40/134; G06F 8/65; G06F 40/14; H04L 29/08

(52) U.S. Cl. CPC G06F 40/134; H04L 67/22; G06F 40/14; G06F 8/65

(57) ABSTRACT

A method comprises: determining, at a web browser, to replace a URL in received webpage code of a first website based at least on an address in an address portion of the URL being to a predetermined tracking domain. The URL includes identification information enabling identification of an address of a second website. The method also comprises: generating a unique tracking value for the URL; replacing the URL in the webpage code with a replacement URL addressed to the second website and including the tracking value in a parameter portion of the replacement URL. The URL is such that a user selection event on a link associated with the replacement URL causes sending of a request including the tracking value to the second website. The second website is configured to extract the tracking value from the request and to provide the tracking value to an attribution system. The method also comprises setting an instruction to respond to the user selection event by causing at least the tracking value to be sent to the attribution system at which the tracking value received from the web browser can be associated with the tracking value received at the second website.

### RELATED APPLICATION

This application claims priority to, and benefit of the filing date of, U.S. Provisional Patent Application No. 63/033,834, filed on Jun. 3, 2020, the content of which is hereby incorporated by reference herein in its entirety

### FIELD OF THE INVENTION

The invention relates to a method in which a URL for a link is replaced with a replacement URL, to enable attribution of user activity at a second website with selection of the link at a first website. The invention also relates to a related computer program product.

### BACKGROUND

It is often wanted to be able to attribute to an owner of a first website (e.g. a publisher website) user navigation to a second website (e.g. an advertiser website) where the user has reached the second website by selection of a link on the first website. Conventionally, a URL associated with the link is addressed to a tracking system and the URL also includes a web address of the second website as a parameter of the URL. When the tracking system receives the request, the tracking system extracts the web address of the second website and redirects to the second website. A cookie associated with the tracking system may be sent to the user device, which enables user activity at the second website to be linked to the first website.

As an alternative to including an address of a webpage of the second website as a parameter of the URL, the URL may include an identifier from which the tracking system can identify the second website. The tracking system can then redirect to the second website.

Browsers may be configured to detect when a domain is used solely for tracking purposes without provision of webpages directly to a user device. When such a domain is detected, the browser may be configured to purge any cookies associated with the domain. This means that user activity at the second website cannot be associated with selection of a link at the first website. Also, the browser may automatically prevent use of cookies relating to other second websites where URLs are addressed to the domain of the tracking system.

It is an object of the present invention to address these issues, enabling tracking of user navigation from a first website to a second website and subsequent navigation.

### SUMMARY OF THE INVENTION

According to a first aspect of the present invention, there is provided a method comprising:

determining, at a web browser, to replace a URL in received webpage code of a first website based at least on an address in an address portion of the URL being to a predetermined tracking domain, wherein the URL includes identification information enabling identification of an address of a second website; generating a unique tracking value for the URL; replacing the URL in the webpage code with a replacement URL addressed to the second website and including the tracking value in a parameter portion of the replacement URL, the URL being such that a user selection event on a link associated with the replacement URL causes sending of a request including the tracking value to the second website, wherein the second website is configured to extract the tracking value from the request and to provide the tracking value to an attribution system; and setting an instruction to respond to the user selection event by causing at least the tracking value to be sent to the attribution system at which the tracking value received from the web browser can be associated with the tracking value received at the second website.

This method overcomes the issues mentioned above. The method enables attribution of user activity at a second website with a user selection event at a first website.

According to a second aspect of the present invention, there is provided a computer program product comprising instructions which, when executed by a computer, cause a browser running on the computer to: determine to replace a URL in received webpage code of a first website based at least on an address in an address portion of the URL being to a predetermined tracking domain, wherein the URL includes identification information enabling identification of an address of a second website; generate a unique tracking value for the URL; replace the URL in the webpage code with a replacement URL addressed to the second website and including the tracking value in a parameter portion of the replacement URL, the URL being such that a user selection event on a link associated with the replacement URL causes sending of a request including the tracking value to the second website, wherein the second website is configured to extract the tracking value from the request and to provide the tracking value to an attribution system; setting an instruction to respond to the user selection event by causing at least the tracking value to be sent to the attribution system at which the tracking value received from the browser can be associated with the tracking value received at the second website.

According to a third aspect of the present invention, there is provided apparatus comprising:

a processing unit; and a computer readable medium having computer program instructions thereon, wherein the processing unit together with the computer readable medium and the instructions are configured to cause a web browser to: determine to replace a URL in received webpage code of a first website based at least on an address in an address portion of the URL being to a predetermined tracking domain, wherein the URL includes identification information enabling identification of an address of a second website; generate a unique tracking value for the URL; replace the URL in the webpage code with a replacement URL addressed to the second website and including the tracking value in a parameter portion of the replacement URL, the URL being such that a user selection event on a link associated with the replacement URL causes sending of a request including the tracking value to the second website, wherein the second website is configured to extract the tracking value from the request and to provide the tracking value to an attribution system; set an instruction to respond to the user selection event by causing at least the tracking value to be sent to the attribution system at which the tracking value received from the browser can be associated with the tracking value received at the second website.

According to a fourth aspect of the present invention, there is provided a method of determining at a web browser running at a client device whether to replace a URL in received webpage code of a first website with a replacement URL, wherein the URL is addressed to a tracking domain for redirection to a second website, and wherein the replacement URL is addressed to the second website, comprising: receiving computer program code including identifiers of one or more browser types; determining information indicative of the type of web browser running at the client device; determining if the type of browser running at the client device type matches the at least one predetermined browser type; and determining if the URL is to be replaced based at least on whether the determined browser type matches the predetermined browser type.

The method may further comprise determining, at the web browser, to replace the URL in received webpage code of a first website also based at least on an address in an address portion of the URL being to a predetermined tracking domain, wherein the URL includes identification information (e.g. a web address of the second website) enabling identification of an address of the second website.

The method may further comprise determining an address for the replacement URL by extracting the identification information from a parameter portion of the URL in the received webpage code.

If it is determined that the URL is to be replaced, the method may further comprise: generating a unique tracking value for the URL; replacing the URL in the webpage code with the replacement URL and including the tracking value in a parameter portion of the replacement URL, the URL being such that a user selection event on a link associated with the replacement URL causes sending of a request including the tracking value to the second website. The second website may be configured to extract the tracking value from the request and to provide the tracking value to an attribution system. The method may further comprise setting an instruction to respond to the user selection event by causing at least the tracking value to be sent to the attribution system at which the tracking value received from the web browser can be associated with the tracking value received at the second website.

According to a fifth aspect of the present invention, there is provided a method of determining at a web browser running at a client device whether to replace a URL in received webpage code of a first website with a replacement URL, wherein the URL is addressed to a tracking domain for redirection to a second website and includes a webpage address at a second website in a parameter portion thereof, and wherein the replacement URL is addressed to the second website, comprising: receiving computer program code including identifiers each identifying one or more predetermined websites; extracting the webpage address of the second website from a parameter portion of the URL; determining if the extracted webpage address corresponds to one of the predetermined websites; and determining if the URL is to be replaced based at least on a result of the determining if the extracted webpage address corresponds. The identifiers may be URLs or domain names, for example.

If it is determined that the URL is to be replaced, the method may further comprise: generating a unique tracking value for the URL; replacing the URL in the webpage code with the replacement URL and including the tracking value in a parameter portion of the replacement URL, the URL being such that a user selection event on a link associated with the replacement URL causes sending of a request including the tracking value to the second website. The second website may be configured to extract the tracking value from the request and to provide the tracking value to an attribution system. The method may further comprise setting an instruction to respond to the user selection event by causing at least the tracking value to be sent to the attribution system at which the tracking value received from the web browser can be associated with the tracking value received at the second website.

Aspects of the invention also provide a computer program product comprising instructions which, when executed by a computer, cause a browser running on the computer to perform the methods of the fourth and fifth aspects. Aspects of the invention also provide apparatus comprising: a processing unit; and a computer readable medium having computer program instructions thereon, wherein the processing unit together with the computer readable medium and the instructions are configured to cause a web browser to perform the methods of the fourth and fifth aspects.

### BRIEF DESCRIPTION OF FIGURES

Embodiments of the present invention will now be described, by way of example only, with reference to the accompanying Figures in which:

FIG. 1 is a block diagram of a system in which attribution of user selection of links may take place;

FIG. 2A is a diagram illustrating functional parts of a conventional tracking URL in received webpage code;

FIG. 2B is a diagram illustrating functional parts of a replacement URL, which replaces the URL in the received webpage code;

FIG. 2C is a diagram illustrating functional parts of a ping URL;

FIG. 3 is a flowchart indicating steps that occur at a client device in accordance with embodiments when tag code is executed;

FIG. 4 is a flowchart indicating steps that occur between remote elements, including the client device, in accordance with embodiments, such that a tracking server can determine that a user has navigated to a second website from a first website.

FIG. 5 is a diagram of a computing device as used in the invention.

### DETAILED DESCRIPTION OF EMBODIMENTS

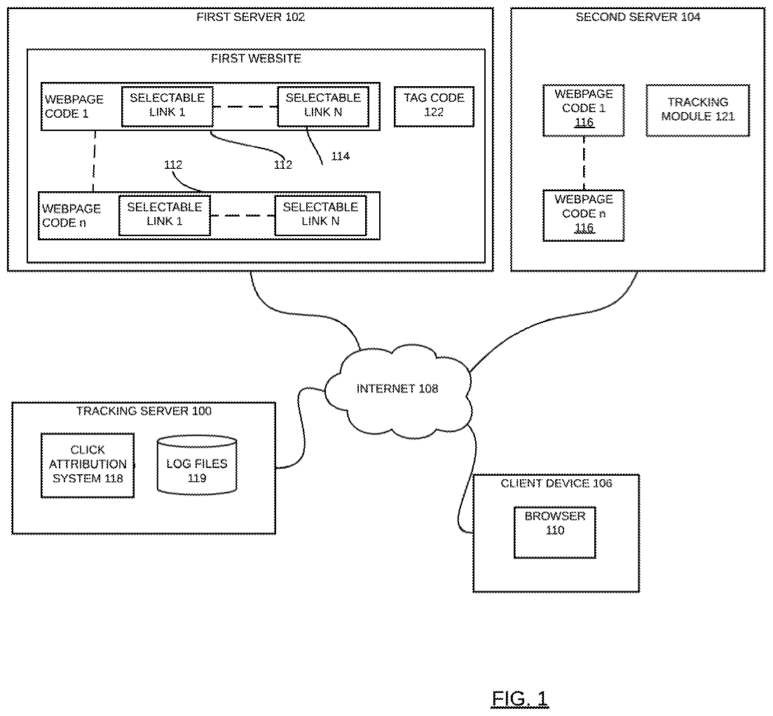

Referring to FIG. 1, a tracking server 100, a first server 102, a second server 104 and a client device 106 are each operatively connected to the internet 108. Although only a single first server 102, second server 104 and client device 106 are indicated in FIG. 1, in practice there are a plurality of the first servers 102, a plurality of the second servers 104 and a plurality of the client devices 106.

The first server 102 hosts a first website. The first website includes webpages 112 and tag code 122. One or more of the webpages 112 each includes one or more selectable links 114. The second server 104 hosts a second website including webpages 116 and a tracking module 121. The client device 106 is configured with a browser 110 installed and running on it. The client device 106 with its browser 108 is operable to send requests for the webpages 112, 116 to the first and second servers 102, 104, and the first and second servers 102, 104 are configured to reply with the requested webpage code. The browser 110 is configured to process received webpage code to display a webpage in a viewport of the browser 110.

Requests and replies described herein are in accordance with HTTP protocol or a successor or derivative protocol, although embodiments of the invention are not limited to communication using any particular protocols. The webpage code is an HTML based document or a document in a successor or derivative language, although embodiments of the inventions are not limited to use of any particular computer languages. The tag code 122 in the webpages 112 may be in Javascript and in this case the browser 110 includes a Javascript engine for compiling of the tag code 122. Embodiments are not limited to where the tag code 122 is in Javascript and alternative languages may be used. Such languages may compile to Javascript.

The tracking server 100 stores a click attribution system 118. The system 118 includes a tracking domain that the tracking server 100 hosts. The tracking server 100 is configured to receive tracking requests sent to the tracking domain. The tracking server 100 also stores a data store of log files 119 and the click attribution system 118 is configured to write to the log files.

The first and second websites are registered with the click attribution system 118. The tag code 122 is added to the first website further to registration. The tracking module 121 is provided to the second website further to the registration.

One or more of the links 114 on each webpage 112 of the first website may be selectable text and/or a selectable element in the webpage. One or more of the links 114 may also be embedded in an advertisement in the webpage. Embodiments of the Invention are not limited to any particular form of link or way in which the link is presented to a user. Each link 114 has an associated underlying URL (referred to as an “original URL”) in the received webpage code. Each URL comprises an address portion having a web address. User selection of the link causes a request to be sent to the respective web address.

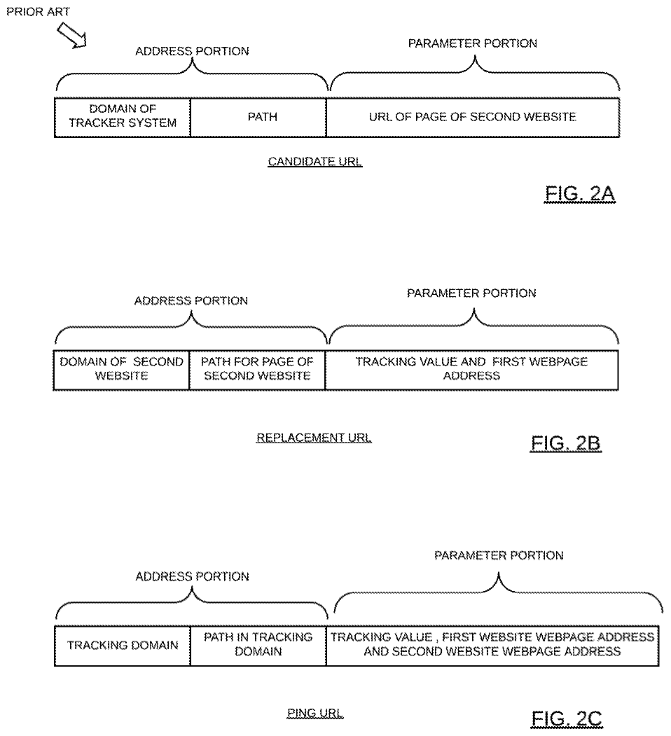

Referring to FIG. 2A, the web address of one or more of the URLs is a web address of the tracking domain. Each of these URLs also includes a parameter portion, which includes information that may be passed to the click attribution application 118. Such information comprises an address of the second website. The address portions and the parameter portions are HTML compliant, although embodiments may not be limited to such. An example form of such a URL is as follows:

tracking_domain.com?...&p=second_websitewebpage.com

Links associated with such URLs are selectable to send requests for a webpage to the tracking domain. Such requests may include the address of the second website in the parameter portion and the address of the webpage on which the link is selected as a referrer. In a conventional manner, the click attribution system 118 is configured to redirect such received requests to the address of the second website and to log the request.

Embodiments of the invention relate to detecting, at the client device 106, candidate URLs for replacement in received webpage code 112 for a webpage of the first website and then determining if any of the candidate URLs are to be replaced. If so, replacement URLs are then generated and the determined candidate URLs each replaced with a corresponding replacement URL. Such replacement URLs are each configured so that user selection of the associated link results in the browser 110 causing sending of a request for a webpage directly to the address of the second website, rather than to the tracking domain. Embodiments of the invention also relate to setting a tracking instruction so that a click attribution request is sent to the tracking server 106 when the link associated with one of the replacement URL is selected. As will be described further below, the webpage request and the click attribution request can be linked by the click attribution system 118, so that user navigation to the second website and user activity at the second website can be associated with user selection of the link at the first website.

The tag code 122 is received at the client device 106 in the webpage code and is executable by the browser 110. The tag code 122 comprises instructions to cause the browser 110 to perform steps described herein. In an alternative, a script may be received with the webpage code, where the script is executable by the browser 10 to cause the browser 110 to fetch the tag code 122 from the first server 102, the tracking server 100, or another remote server.

In some embodiments, the tag code 122 is then executable to directly parse the webpage code, as described further below. In other embodiments, the tag code 122 is configured to first determine whether replacement of URLs should take place at all based on whether one or more rules are met.

One such rule requires that replacement of URLs take place where the browser 100 is one or more type and optionally one or more versions of the respective one or more types. In this case, an identifier of the browser type (e.g. Chrome, Firefox, Internet Explorer, Safari) and optionally version is first determined. The browser type and optionally the version may be determined by fetching the user agent, which includes an identifier of the browser and version. The tag code 122 stores identifiers of browser types for which replacement of URLs should take place, that is, of browsers with which tracking problems may arise where URLs such as those indicated in FIG. 2A are selected. The tag code 122 is executable to determine whether there is a match between the determined browser type and the predetermined browser types, and optionally also versions. If there is no match, the tag code 122 is configured to discontinue execution. In a variant embodiment, the tag code 122 may store identifiers of browser types and optionally versions such that execution of the tag code 122 is discontinued if there is a match.

The tag code 122 includes the domain name of the tracking domain. The tag code 122 is executable at the browser 108 to parse the webpage code to identify the candidate URLs in the webpage code received from the second server 104 based on whether the domain name matches to the domain of the address in the address portion. If so, the URL is a candidate URL for replacement.

In some embodiments, the click attribution system 118 may include a plurality of tracking domains each hosted by the tracking server 100. In this case, the tag code 122 may be executable at the browser 108 to parse the webpage code to identify the candidate URLs in the webpage code received from the second server 104 based on whether the address in the address portion is at one of the predetermined tracking domains.

Additionally or alternatively, instead of the tag code 122 being executable to match one or more stored domain name against URLs in the webpage code, the tag code 122 is configured with a character string. In this case, the tag code 122 is executable to parse the webpage code to identify the candidate URLs based on whether the address in the address position includes the character string. This may be useful where a plurality of tracking domain names have similar domain names including the same character string.

In some embodiments, candidate URLs may be replaced without regard to browser type or version.

Although not essential, in some embodiments, the tag code 122 may include one or more further rules defining which of the original URLs are candidate URLs.

One such further rule may require that a webpage address is present as a parameter in the parameter portion of the candidate URL. If no such webpage is present, execution of the tag code 122 is discontinued.

As already mentioned, there are in practice a plurality of the second servers 104 and second websites. Another such further rule may require that the web address in the parameter portion of the candidate URL is at one of a predetermined plurality of the second websites, where a list of domain names for such websites is in the tag code 122. Such a further rule may be useful since some websites registered with the click attribution system 118 may be configured for use where requests are redirected from the tracking server 100, but not where requests derive from a replacement URL. Thus, domain names for a subset of the second websites are listed, where those websites have a respective properly configured tracking module 121 for handling requests deriving from user selection of links associated with the replacement URLs. In a variant, the tag code 122 may include a list of second websites that may feature in the parameter portions of candidate URLs, but whose tracking modules 121 are not configured to handle requests from the replacement URLs.

If the candidate URL is to be replaced, the tag code 122 is executable to generate a click identifier attribution (CIA) value unique to the particular instance of user selection of the link and to the client device 106. A tracking value is then formed by concatenating the second website address and the click attribution value. The tag code 122 is also executable to then: a) generate a replacement URL including the tracking value, and to replace the candidate URL with the replacement URL; and b) to generate and set a tracking instruction to detect user selection of the link for the replacement URL and to send a tracking request to the click attribution system 118 at tracking server 100.

Referring to FIG. 2B, the replacement URL includes an address of a webpage of the second website in the address portion of the URL and the tracking value in the parameter portion of the replacement URL. An example form of such a URL is as follows: second_website_address.com?p=tracking_value&referrer=first_website_address

The tracking instruction is configured so that the tracking request includes the tracking value and the address of the first website on which the user selection occurs. The address of the first website may be included in as a referrer in the tracking request. For example, referring to FIG. 2C, a tracking URL may be set as a ping attribute associated with the replacement URL. Such an example tracking URL is as follows: Tracking_domain.com/path.php?trackingvalue=[123]&referrer=first_website_address

Embodiments of the invention are not limited to any particular method for implementing the tracking instruction. As an alternative to setting a ping attribute, the setting the tracking instruction may comprise setting a beacon, configured so that user selection of the link causes sending the tracking request to the click attribution system 118. As another alternative, the setting the tracking instruction may comprise setting an event handling instruction (e.g. an event handler in JavaScript), configured so that user selection of the link causes sending the tracking request to the click attribution system 118.

The tracking domain to which the tracking request is sent may be the same tracking domain as that specified in the original URL. In some embodiments however, the tracking domain may be different. In this case, the tag code 122 includes an address for different tracking domain and, configures the tracking instruction so that the tracking request is sent to the different tracking domain. In FIG. 2C, the ping URL would thus include the address for the different tracking domain.

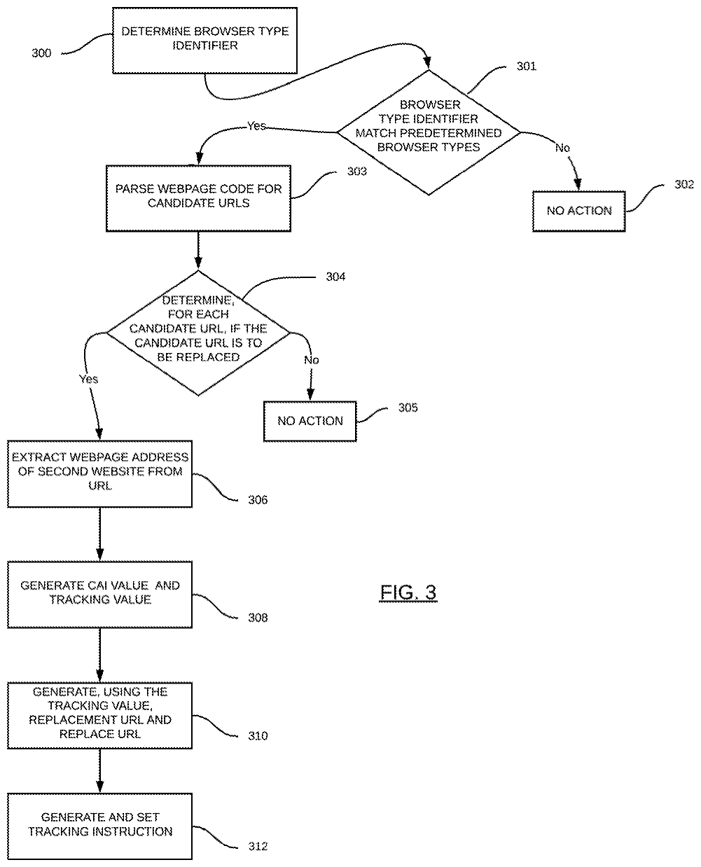

Referring to FIG. 3, execution of the tag code 122 is now described. When the tag code 122 is executed, first, it is determined whether the browser is of a type that may cause problems with tracking. Accordingly, an identifier of the browser type is determined at step 300 and then the identifier of the browser type is compared with the predetermined browser type identifiers in the tag code 122. If the browser type identifier does not match any one of the predetermined identifiers, no further action is taken and execution of the tag code 122 ends at step 302.

If the browser type identifier matches one of the predetermined identifiers, the webpage code is then parsed to identify the candidate URLs (step 303) from amongst the original URLs based on whether one of the predetermined domain names matches the domain of the address portion of the original URL. If there is a match, the original URL is a candidate URL.

At step 304, it is determined, for each candidate URL, whether the candidate URL is to be replaced by comparing predetermined domain names of the second websites 104 with the second website address in the candidate URL. If the address portion of the respective candidate URL does not include one of the predetermined domain names, execution of the tag code 122 ends at step 305.

Provided the address of the second website in the candidate URL matches with one of the predetermined domain names, then at step 306 the webpage address of the second website is extracted from the parameter portion of the candidate URL at step 307.

A CIA value is generated at step 308. The CIA value is generated by concatenating the original URL, a random number and a current time stamp, and hashing the concatenation. The random number may be generated using a generator built into the operating system of the client device 106. This process results in the CIA value being unique to a page impression. Since user selection of any of the links for candidate URLs on the webpage navigates away from the first website, the CIA value can be considered as unique to the particular user selection (e.g. “click”). Embodiments of the invention are not limited to any particular way in which the CIA value is generated. In particular, embodiments are not limited to any order of concatenation or any particular hash function.

At step 310, a tracking value is generated, which comprises a concatenation of the webpage address of the second website and the CIA value. Embodiments are not limited to any order of concatenation.

At step 312, the replacement URL is generated with the webpage of the second website in the address portion of the replacement URL and the tracking value in the parameter portion of the replacement URL.

At step 314, the candidate URL in the webpage code is replaced with the replacement URL.

At step 316, before, after or alongside steps 312 and 314, the tracking instruction is generated and set at the browser 110 so that a tracking request is sent to the click attribution system 118 on user selection of the link.

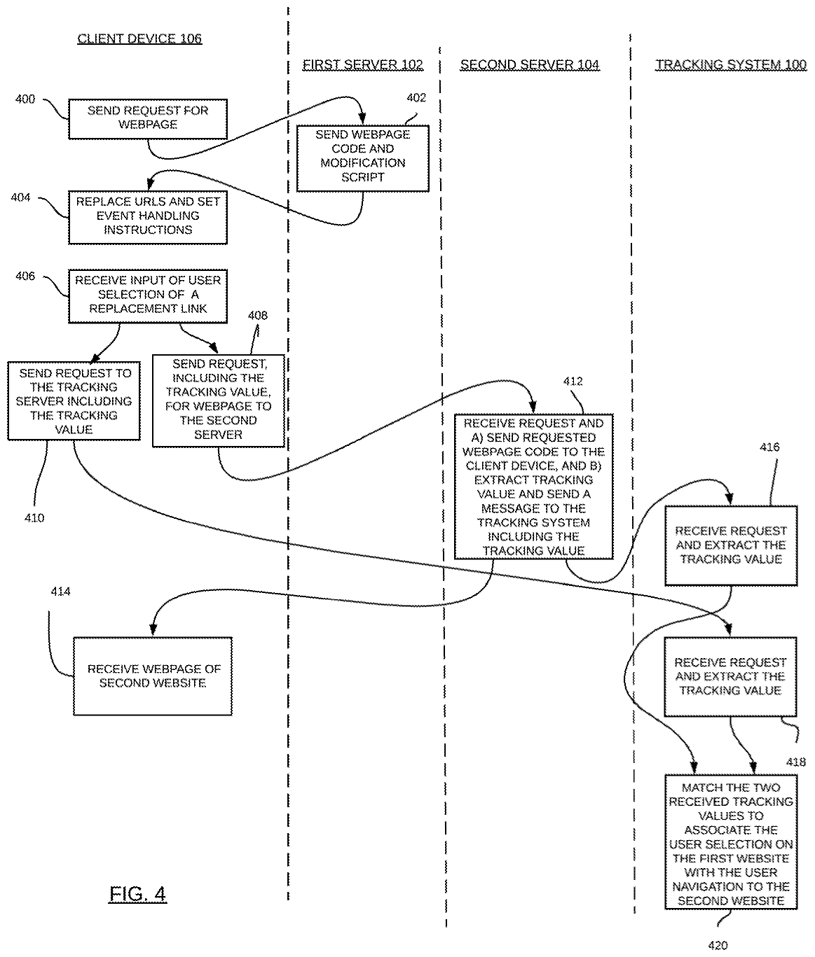

Referring to FIG. 4, example operation of the system is now described. At step 400, a user operates the client device 106 to send a request for a webpage of the first website to the first server 102. At 402, the first server 102 sends the webpage code for the requested webpage and also sends the tag code 122. At step 404, the browser at the client device 106 receives the tag code 122 and the webpage code and executes the tag code 122 before the webpage is unloaded. At least one of the original URLs is replaced with a respective replacement URL and the associated tracking instruction is set, as described with reference to FIG. 3.

The client device 106 then receives input of a user selection of a link for one of the replacement URLs at step 406. In response, the browser sends a request to the second server 104 for a webpage specified in the address portion of the replacement URL at step 408. Also, in response, at step 410 the tracking instruction causes the browser to detect that the link has been selected and to send a tracking request to the click attribution system 118. Steps 406 and 408 may take place in any order or in parallel.

The second server 104 then receives the request at step 412. The second server 104 receives the request and replies with the requested webpage at step 414. At step 416 the tracking module 121 at the second server 104 extracts the tracking value from the received request, generates a request that includes the tracking value and sends the request to the click attribution system 118. The tracking system 100 then receives the request from the second server 104, extracts the tracking value and the address of the second server 104 from the request at step 418. The click attribution system 118 then matches the tracking value received from the second server 104 with the tracking value received from the client device 106 at step 420. The click attribution system 118 logs this in the logs 119. Thus, the user's navigation to the second website is linked to the user selection of the link on the first website.

Conventionally, some candidate URLs are configured with identifiers enabling identification of one of the second website by a tracking server to which the candidate URLs are addressed and at which redirection to that second website takes place, but which are not addresses. Conventionally, the server maintains a mapping between each of the identifiers and an address at one of the second websites. The server is thus able to determine an address to redirect to based on the receive identifier and the mapping.

As an optional one of the further rules, the tag code 122 may be configured to handle candidate URLs that have an identifier enabling identification of one of the websites as a parameter. In this case, the tag code 122 includes a mapping between identifiers and the second websites, like a server conventionally. In this case, as an additional step the tag code 122 may be configured to extract the identifier from the candidate URL and determine if an identifier of one of the second websites can be determined using the mapping. In some embodiments, the tag code 122 may be configured to only handle candidate URLs that include such identifiers as parameters.

The second website may be of an advertiser. The first website may be of a publisher. The click attribution system 100 may be of an advertising network, for example an affiliate network. The identifier enabling identification of one of the websites may be an affiliate identifier.

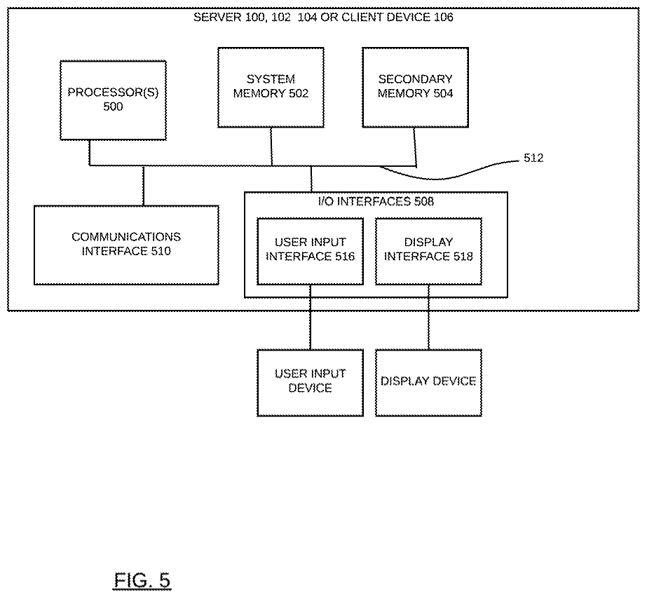

The servers 100, 102, 104 and the client device 106 may each be implemented using a general-purpose computing device. Referring to FIG. 5, such a computing device 500 includes one or more processors 502, a system memory 504, a secondary memory 506, input/output (I/O) interfaces 508, a communications interface 520, all coupled by a bus 512. Multiple computing devices such as that illustrated in FIG. 5 may be used to implement the described functionality; for example, software components running on a variety of different computing devices may collaborate to provide the functionality.

Instructions executable to perform steps of embodiments of the invention may be stored in the system memory 504 or the secondary memory 506. The one or more processors 502 may be any type of processor suitable for execution of such instructions, including but not limited to a general-purpose digital signal processor or a special purpose processor. In some embodiments, electronic circuitry including, for example, programmable logic circuitry, field-programmable gate arrays (FPGA), or programmable logic arrays (PLA) may execute the instructions by utilizing state information of the instructions to personalize the electronic circuitry, in order to perform aspects of the present invention.

The system memory 504 and the secondary memory 506 may be implemented using any suitable memory technology. The system memory 504 includes RAM or other dynamic, volatile storage (e.g. SDRAM, DDR SDRAM, RDRAM, SRAM, etc.), and ROM or other non-volatile memory (e.g. PROM, EPROM, EEPROM, Flash memory), for storing data and instructions for execution by the one or more processors 502. Typically, the computing device 500 includes an operating system (OS) stored in the non-volatile memory. The client device 106 also includes web browser code in the non-volatile memory, which is executable in the volatile memory during runtime. The secondary memory 506 may include, for example, a hard disk drive and/or a removeable storage device by which removable storage media can be accessed. The term “memory” is used herein to refer to any physical component that can retain or store instructions and data on a temporary or permanent basis. Instructions and data are stored in the system memory 504 and/or the secondary memory 506 and are accessible by the one or more processors 502 and enable the computing device 500 to implement embodiments of the present invention as described herein.

The communications interface 520 allows software and data to be transferred between the computer device 500 and external devices, via a local network or via the Internet or other network. The communications interface may support communication via any suitable wired or wireless general data networks, such as types of Ethernet network, telecommunications/telephony networks, for example, or via any other suitable type of network and/or protocol.

The I/O interfaces 508 include at least one user input interface 516 and at least one display interface 518. The at least one input interface 516 may be coupled to a user input device in the form of a keyword, mouse, trackball, etc. the display interface may be coupled to a display device. The display device and the user input device may be combined in the form of a touch screen.

While the client device 106 may be implemented in the same way as the servers 100, 102 and 104, the client device 106 may be a personal computer, a tablet, a smartphone, or any device capable of running a web browser.

Aspects of the present invention are described herein with reference to flowchart illustrations and/or block diagrams of methods, apparatus (systems, and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or can be carried out by combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention.

The applicant hereby discloses in isolation each individual feature or step described herein and any combination of two or more such features, to the extent that such features or steps or combinations of features and/or steps are capable of being carried out based on the present specification as a whole in the light of the common general knowledge of a person skilled in the art, irrespective of whether such features or steps or combinations of features and/or steps solve any problems disclosed herein, and without limitation to the scope of the claims. The applicant indicates that aspects of the present invention may consist of any such individual feature or step or combination of features and/or steps. In view of the foregoing description it will be evident to a person skilled in the art that various modifications may be made within the scope of the invention.

We claim:

1. A method comprising:
determining, at a web browser, to replace a URL in received webpage code of a first website based at least on an address in an address portion of the URL being to a predetermined tracking domain, wherein the URL includes identification information enabling identification of an address of a second website;
generating a unique tracking value for the URL;
replacing the URL in the webpage code with a replacement URL addressed to the second website and including the tracking value in a parameter portion of the replacement URL, the URL being such that a user selection event on a link associated with the replacement URL causes sending of a request including the tracking value to the second website, wherein the second website is configured to extract the tracking value from the request and to provide the tracking value to an attribution system;
setting an instruction to respond to the user selection event by causing at least the tracking value to be sent to the attribution system at which the tracking value received from the web browser can be associated with the tracking value received at the second website.

2. The method of claim 1, further comprising:
requesting a webpage;
in reply receiving the webpage code from the first website, and tag code;
processing the tag code at the browser to cause the generating, the replacing and the setting.

3. The method of claim 1, wherein the tracking value comprises an attribution value, wherein generating the tracking value comprises generating the attribution value based at least on one or more of:
the address of the second website;
a timestamp of receipt of the webpage code;
a random number.

4. The method of claim 1, wherein the instruction is also set to respond to the user selection event by causing sending to the attribution system of an identifier of the webpage and/or an identifier of the second website, in association with the tracking value.

5. method of claim 1, wherein the setting the instruction comprises selling a ping URL configured to respond to the user selection event.

6. The method of claim 1, wherein the setting the instruction comprises selling a beacon event associated with the link, such that selection of the link causes the beacon event to send the tracking request.

7. The method of claim 1, before the determining to replace the URL, detecting the URL by parsing the received webpage code to detect URLs addressed to the tracking domain, wherein the URL to be replaced is one such URL.

8. The method of claim 7, wherein the determining to replace the URL comprises determining that identification information enabling identification of an address of a second website is present in the URL.

9. The method of claim 8, wherein the determining to replace the URL further comprises: comparing the identification information with predetermined information identifying a plurality of websites, and the determining to replace the URL is based on whether the identification information matches to one of the websites.

10. The method of claim 8, wherein the identification information comprises an identifier that does not independently provide an address for the second website, the determining to replace the URL further comprising:
receiving at the browser mapping information mapping the identification information and the address;
determining the address using the mapping information.

11. The method of claim 1, further comprising, before the determining to replace the URL:
determining information indicative of the browser type;
determining that the URL is to be replaced based at least on the browser type.

12. The method of claim 1, wherein the URL is replaced before the received webpage code is unloaded by the browser.

13. The method of claim 1, further comprising:
determining user selection of the link;
sanding a request for the corresponding webpage to the second website using the replacement URL, the request including the tracking value;
activating the instruction to send the tracking value to the attribution system.

14. The method of claim 13, further comprising:
at a server hosting the second website, receiving the request for the webpage;
extracting the tracking value;
sending the tracking value to the attribution system.

15. A computer program product comprising instructions tangibly stored thereon which, when executed by a computer, cause a browser running on the computer to:
determine to replace a URL in received webpage code of a first website based at least on an address in an address portion of the URL being to a predetermined tracking domain, wherein the URL includes identification information enabling identification of an address of a second website:
generate a unique tracking value for the URL;
replace the URL in the webpage code with a replacement URL addressed to the second website and including the tracking value in a parameter portion of the replacement URL, the URL being such that a user selection event on a link associated with the replacement URL causes sending of a request including the tracking value to the second website, wherein the second website is configured to extract the tracking value from the request and to provide the tracking value to an attribution system;
setting an instruction to respond to the user selection event by causing at least the tracking value to be sent to the attribution system at which the tracking value received from the browser can be associated with the tracking value received at the second website.

16. Apparatus comprising:
a processing unit;
a computer readable medium having computer program instructions tangibly stored thereon, wherein the processing unit together with the computer readable medium and the Instructions are configured to cause a web browser to:
determine to replace a URL in received webpage code of a first website based at least on an address in an address portion of the URL being to a predetermined tracking domain, wherein the URL includes identification information enabling identification of an address of a second website;
generate a unique tracking value for the URL;
replace the URL in the webpage code with a replacement URL addressed to the second website and including the tracking value in a parameter portion of the replacement URL, the URL being such that a user selection event on a link associated with the replacement URL causes sending of a request including the tracking value to the second website, wherein the second website is configured to extract the tracking value from the request and to provide the tracking value to an attribution system;
set an instruction to respond to the user selection event by causing at least the tracking value to be sent to the attribution system at which the tracking value received from the browser can be associated with the tracking value received at the second website.
